(19) United States
(12) Patent Application Publication
(10) Pub. No.: US 2005/0002591 A1
(43) Pub. Date: Jan. 6, 2005

(54) Telescoping Slide

(75) Inventor: Michael Buitmann, Gersten (DE)

Correspondence Address: GUDRUN E. HUCKETT DRAUDT, LONSSTR. 53, WUPPERTAL, 42289, DE

(73) Assignee: HEINRICH J. KESSEBOHMER KG, Bad Essen (DE)

(21) Appl. No.: 10/709,667

(22) Filed: May 21, 2004

(30) Foreign Application Priority Data
May 22, 2003 (DE) 103 23 773.9

(51) Int. Cl. F16C 17/26; A47B 88/00

(52) U.S. Cl. 384/35

(57) ABSTRACT

A telescoping slide has an outer part and an inner part that is telescopingly movable within the outer part. At least one slide bearing is arranged between the outer and inner parts for axially guiding the at least one inner part within the outer part. The slide bearing has at least one composite body having at least one dimensionally stable support layer and at least one elastic compensation layer. In an alternative, the slide bearing has at least one monolithic support member having a first side forming a sliding surface on a first one of the inner and outer parts and having a second side provided with shaped projections that in a mounted position of the slide bearing provide an elastic contact structure on a second one of the inner and outer parts.

### BACKGROUND OF INVENTION

The invention relates to a telescoping slide comprising particularly a tubular outer part and at least one inner part that is axially telescopingly movable in the outer part, wherein these two telescoping parts are axially guided by means of a slide bearing arranged between them.

### SUMMARY OF INVENTION

It is an object of the present invention to provide a telescoping slide of the kind disclosed in DE 100 20 866 A1 whose axially movable parts can be mounted with minimal expenditure, can be centered in the guide position, and can be reliably moveable without readjustment of the slideway play for a long period of time.

In accordance with the present invention, this is achieved in that the slide bearing is provided with at least one two-layer or multi-layer composite body that is comprised of at least one dimensionally stable support layer and at least one elastic compensation layer.

The telescoping slide according to the invention is provided in the area between its at least two axially movable components with a semifinished support that is embodied in particular as a two-layer composite body wherein a dimensionally stable support layer and an elastic compensation layer are connected to a functional unit. When mounting the two telescoping parts and the interposed semifinished composite body in a first mounting phase, an optimal radial press connection can be produced, wherein the telescoping parts by means of the elastic compensation layer of the composite body can be positioned relative to one another in their appropriate position of use.

In this connection, the elastic layer that is provided on the support layer is effective in particular as a compensating and centering layer that compensates shape deviations and positional deviations of the telescoping parts. After completing the first mounting phase, the elastically pretensioned layer, while maintaining the provided centering position, can be changed with regard to its degree of hardness.

The composite body that is secured in this connected position by the elastic-hardened compensation layer can be treated in the subsequent second mounting phase by a mechanical, thermal, chemical, electrical and/or magnetic treatment such that in the area of the already elastically deformed compensation layer at least partially a local hardening or curing takes place. In this way, the spaced apart position between the outer part and the inner part predetermined by the composite body is permanently fixed so that an optimal guiding action is provided for the translatory movements occurring during use.

With this application of the composite body according to the invention, in the pretensioning phase the required slide bearing (slideway) play that is needed for the axial translatory movements of the telescoping slide is generated wherein the play can be provided almost with a “zero”tolerance. In this way, the readjustments and realignments that have been required in the past in connection with slide bearing components of known telescoping slides is no longer necessary and, when employing a shrinking intermediate layer (for example, see DE 100 20 866.5), a slideway play that is too imprecise is prevented.

In accordance with the material of the tubular outer and inner parts, particularly a plastic material having optimal sliding properties is provided for the support layer that is dimensionally stable so that the slide bearing provided according to the invention with a fixed and precise guide area can be operated free of wear for a long period of time because of minimal friction; moreover, smooth running properties are ensured.

According to a further embodiment, the slide bearing is provided with a monolithic support body that has on the side facing away from the sliding surface a contact structure with shaped projections that provides a type of the compensation layer. In this area, the support member that is secured in a clamped securing position between the telescoping parts is fixed by means of an adhesive or the like such that the radial compensating and centering position of the telescoping parts relative to one another is maintained in the mounting phase.

### BRIEF DESCRIPTION OF DRAWINGS

FIG. 1 is a schematic section view of a telescoping slide with an outer part and an inner part.

FIG. 2 is an end view of the telescoping slide, partially sectioned, according to the line II-II of FIG. 1.

FIG. 3 is perspective view of a mounted telescoping slide with cylindrical telescoping parts.

FIG. 4 is an end view of the telescoping slide according to FIG. 3 with three tubular telescoping parts.

FIG. 5a detail view, partially sectioned, of the telescoping slide in the area of the upper and lower slide bearings.

FIG. 6 is a section view approximately according to the line VI-VI of FIG. 5 and the line III-III of FIG. 3.

FIG. 7 is a detail view of a support member forming a slide bearing in the form of a half shell.

FIG. 8 is a perspective individual illustration of support member that is provided at the topside of the telescoping slide of FIG. 4.

FIG. 9 is a section view of a telescoping slide of a second embodiment having a substantially rectangular cross-sectional contour.

FIG. 10 shows a detail view of the support members used in the telescoping slide of FIG. 9.

FIG. 11 shows another detail view of the support members used in the telescoping slide of FIG. 9.

FIG. 12 shows another detail view of the support members used in the telescoping slide according to FIG. 9.

FIG. 13 shows yet another detail view of the support members used in the telescoping slide of FIG. 9.

FIG. 14 shows a partially sectioned view of the telescoping slide in the position of use.

### DETAILED DESCRIPTION

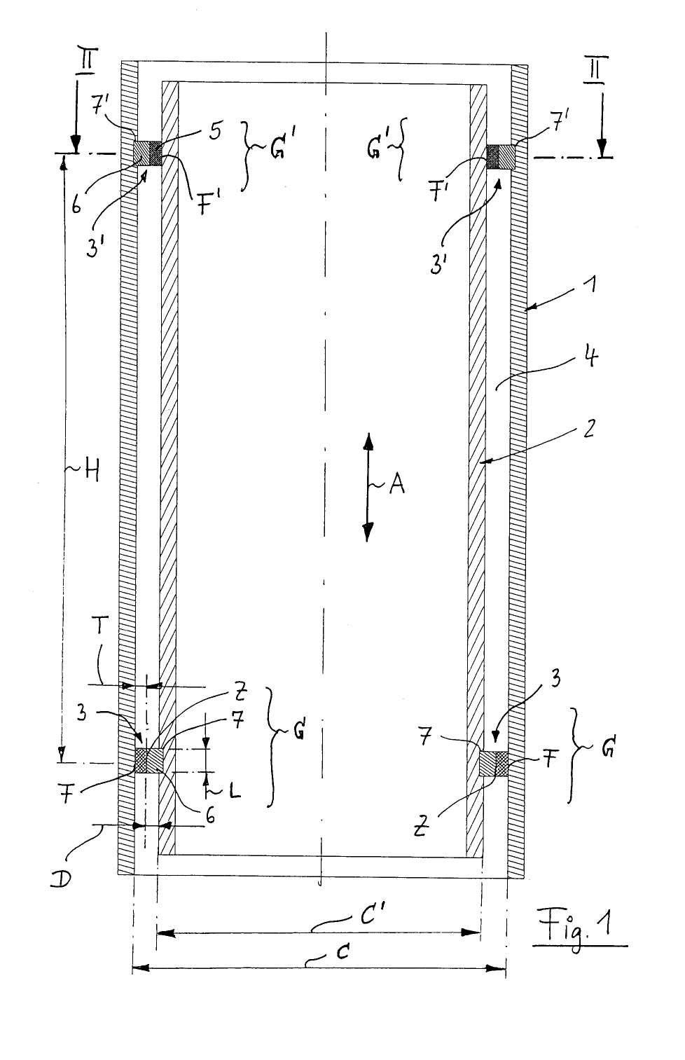

The FIG. 1 shows a telescoping slide with, in particular, a tubular outer part 1 and an inner part 2 that is movable relative to the outer part 1, i.e., can move in and out (telescope) relative to the outer part 1 (movement arrow A). These two telescoping parts 1 and 2 are connected to one another by slide bearings identified as such by G, G′ such that in the direction of the arrow A the resulting movement is axially guided. It is also conceivable that the telescoping slide is provided with more than one inner part 2 (not illustrated) and that corresponding slide bearings are provided between the inner parts, respectively.

For the configuration of the slide bearings G, G′ according to the invention, at least one composite body 3 is provided that can be introduced into the intermediate space 4 between the telescoping parts 1 and 2. In this connection, the composite body 3 is comprised of at least one dimensionally stable support layer 5 and an elastic compensation layer 6 with which the functional effect of the composite body 3 is achieved already after completion of a mounting phase that is not illustrated in detail. The compensation layer 6 for this purpose is manufactured of an elastic and deformable (plastic or synthetic) material that during mounting of the composite body 3 into the intermediate space 4 is usable as a compressible area in order to connect simply and quickly the parts 1 and 2 without requiring additional measuring expenditure or complex auxiliary tools.

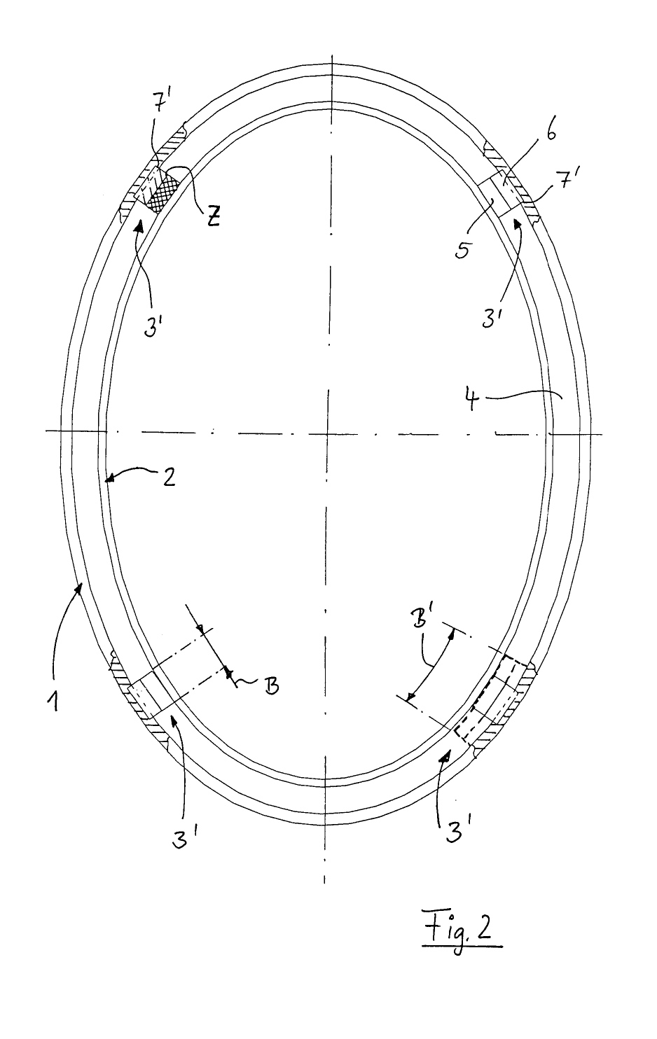

After reaching the mounting position illustrated in FIGS. 1 or 2, the compensation layer 6 that is elastically pretensioned/clamped or has an elastic-solidified state can be fixed for securing the composite body 3 and the parts 1, 2. Advantageously, the compensation layer 6 is made of a material that can be cured or hardened with minimal expenditure. Hardening can be carried out with time delay after completion of the first tensioning mounting phase so that on the telescoping slide, i.e., on the outer or inner parts 1, 2, additional components (not illustrated) can be mounted; hardening or curing is carried out subsequently in the area of the composite body 3.

It is conceivable that the elastic material is matched to the pressure conditions within the intermediate space 4 such that already the effective mechanical pressure forces after a certain action time lead to hardening or curing of the compensation layer 6.

By means of the composite body 3 positioned in the mounting position between the telescoping parts 1 and 2, centering of the telescoping parts 1 and 2 in their proper position of use is achieved. In this connection, the elastic compensation layer 6 can also expand back wherein already with partial curing of the compensation layer 6 that provides the tensioning and pressing position of the composite body 3 a fixation of the telescoping parts 1, 2 in the radial direction is effected and, in this way, an axial movability (arrow A) of the parts 1 and 2 remains intact.

The composite body 3 according to the invention is provided as a pre-manufactured semifinished support that with regard to its constructive configuration can be matched as desired to the configuration of the telescoping parts 1, 2, respectively. It is conceivable in this connection that, instead of the elliptical cross-section of the telescoping parts 1, 2 illustrated in FIG. 2 circular, oval, triangular, quadrangular, or polygonal cross-sections can also be mounted in combination with appropriate composite bodies 3. The composite body 3 that is manufactured as an individual part has a length L and a width B wherein it is conceivable to produce the composite body 3 as a sleeve part having a closed ring shape or as a segment arc (radian measure B; FIG. 2, right side, dashed illustration) that can be matched to the radial contour of the components.

The thickness D illustrated in FIG. 1 of the elastic compensation layer 6 is dimensioned or sized such that dimensional and shape tolerances, for example, concerning the inner diameter C of the outer part 1 or the outer diameter C′ of the inner part 2 can be compensated such that these dimensional tolerances can be tolerated by the slide bearing G and an additional adjustment or fine positioning of the parts 1 and 2 relative to one another after completion of installation and after hardening of the composite body 3 is not required.

In an advantageous configuration, the composite body 3 in the area of the supporting layer 5 and the compensation layer 6 is formed of a plastic layer, respectively. It is understood that a substantially variable thickness T of the supporting layer 5 is comprised of a plastic material that ensures minimal friction, minimal wear, and smooth running properties; such a plastic material, based on its guiding properties, is already used in connection with adjustable slide bearings of the prior art. The compensation layer 6 that is to be applied as a second component onto the supporting layer 5 can be comprised of an elastic base material with additives with which the described hardening or curing of the compensation layer 6 can be effected. For this hardening after mounting, a mechanical, thermal, chemical, electrical and/or magnetic treatment of the compensation layer 6 is conceivable.

According to another embodiment it is conceivable that the composite body 3 in the area of the supporting layer 5 is partially or completely comprised of a metallic or non-metallic material that is provided with the compensation layer 6. Also, it is conceivable that the compensation layer 6 is in the form of a spring part (not illustrated) that is connected as an elastic auxiliary component to the supporting layer 5 acting as a support part, wherein these individual parts are mounted as a unit.

Moreover, the composite body 3 can have more than the two layers 5 and 6 (not illustrated) wherein the compensation layer 6 can be arranged between two of the supporting layers; two partial areas of the elastic material can be provided so as to be aligned gap to gap on the supporting layer 5; or the supporting layer 5 is provided on either side with a compensation layer. In an expedient embodiment, the composite bodies 3 (dimensions B, L) that can have essentially any shape are comprised of material-bonded layers 5 and 6 wherein it is also conceivable to secure the compensation layer 6 sufficiently tightly by positive-engaging or non-positive engaging connecting sections in the area of a connecting zone Z on the supporting layer 5.

In the illustration according to FIG. 1, the slide bearings G′ positioned at a spacing H to the lower slide bearings G are provided with different composite bodies 3 or 3′. As a result of the selected sliding movement A, the composite bodies 3 on the inner part 2, especially at G, and the composite bodies 3′ on the outer part 1, especially in the area of the slide bearing G′, are stationarily secured so that an alternating support action is achieved. It is also conceivable to provide several of the appropriate composite bodies 3, 3′ in the axial direction on the respective telescoping parts 1 and 2 (not illustrated).

In the illustrated embodiment, one side of the composite body 3 is connected positive-lockingly by means of its compensation layer 6 on the inner part 2 (at G) and the composite body 3′ is connected by means of its compensation layer 6 positive-lockingly on the outer part 1 (at G′). The free contact side of the supporting layer 5 defines thus the sliding surface F, F′ of the slide bearings G, G′, respectively.

It is also conceivable that for fixation of the composite body 3, 3′ the supporting layer 5 is used (it is then not loaded by sliding friction). Accordingly, the compensation layer 6 after hardening forms on its free contact side a new sliding surface (not illustrated) so that by means of its guiding properties the component function is determined.

In the illustrated embodiment according to FIGS. 1 and 2, the supporting layer 5 positively engages by means of a shaped recess 7, 7′, for example, an annular groove, the corresponding telescoping part 1, 2, respectively. It is also conceivable to provide the support action of the composite body 3, 3′ on the respective telescoping part 1, 2 by means of a material-bonding fixation, for example, by means of soldering or adhesive connections.

The contact zone that forms the sliding surface F, F′ of the composite body 3, 3′ is according to an expedient embodiment optimized in accordance with the material of the telescoping parts 1, 2, wherein, for example, matching of the sliding surface F, F′ to the metallic or non-metallic surfaces, preferably to aluminum, can be provided. Also, sliding connections in the area of a coat of paint, a powder coating, or the like surface coatings is possible. The afore described configuration of the composite bodies 3, 3′ with optimal friction and wear values can be used, for example, in connection with telescoping support legs that are used on height-adjustable tables, chairs, or the like.

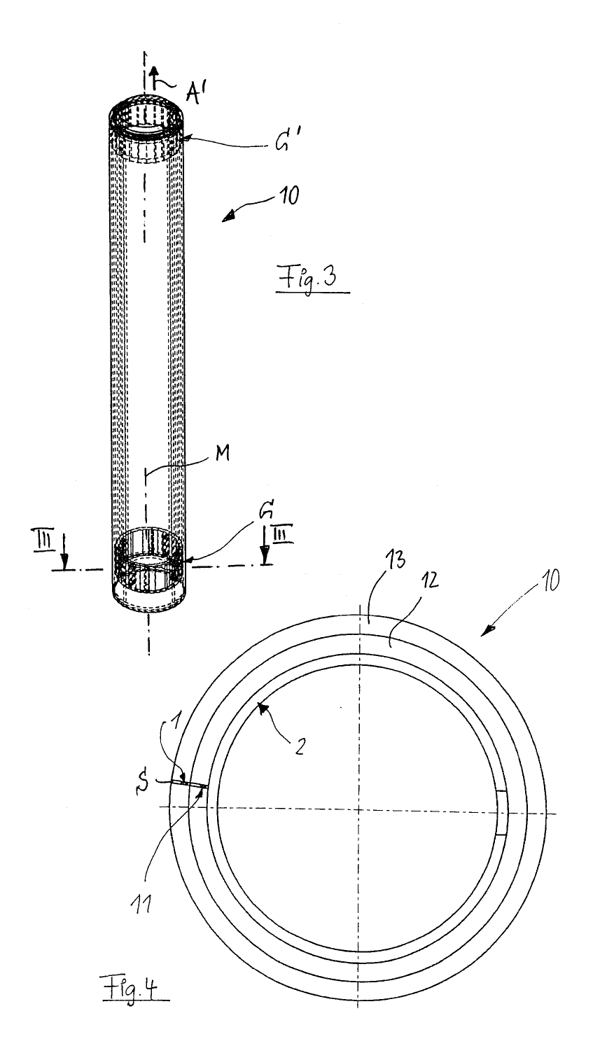

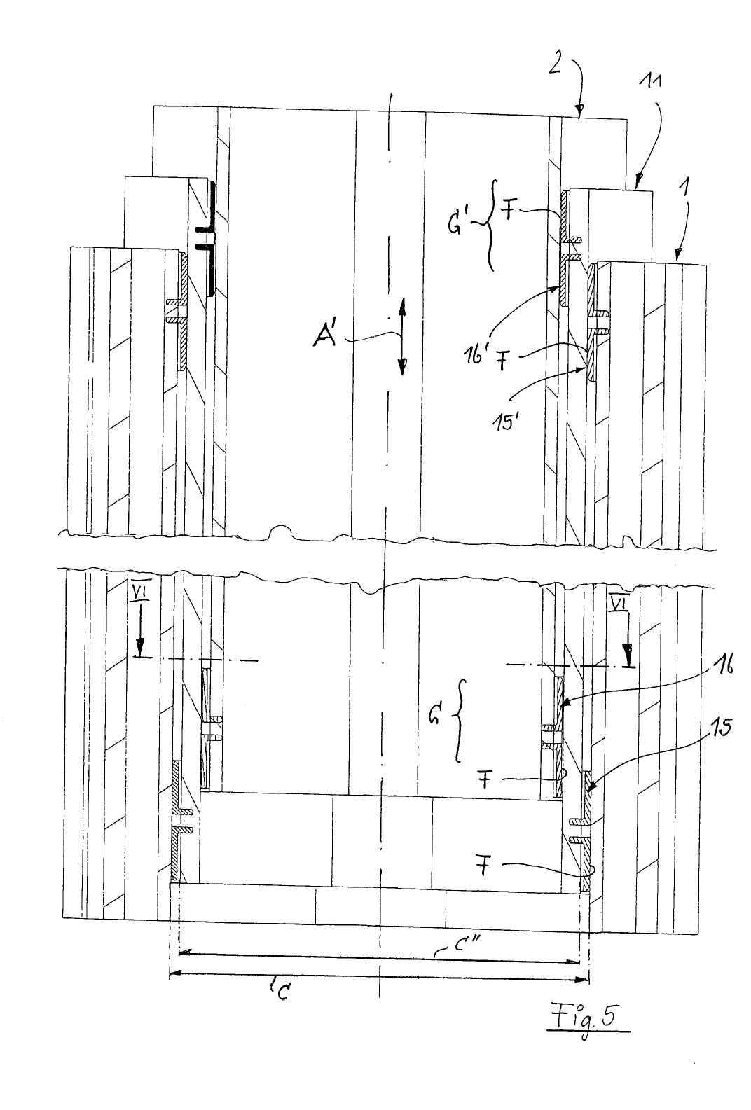

In FIG. 3, a telescoping slide 10 formed of cylindrical pipe sections is illustrated that is provided, for example, for a position-adjustable kitchen furniture parts or the like. The telescoping slide 10 has in the direction of its central longitudinal axis M a lower and an upper slide bearings G, G′ that are spaced apart from one another with which the inner part 2, a center part 11, and the outer part 1 art axially movably supported relative to one another (FIG. 5, arrow A). The plan view according to FIG. 4 shows that the telescoping slide 10 at its top is closed by cover caps 12, 13, respectively. The caps have a slotted area S through which the parts 1 and 11 positioned underneath are visible.

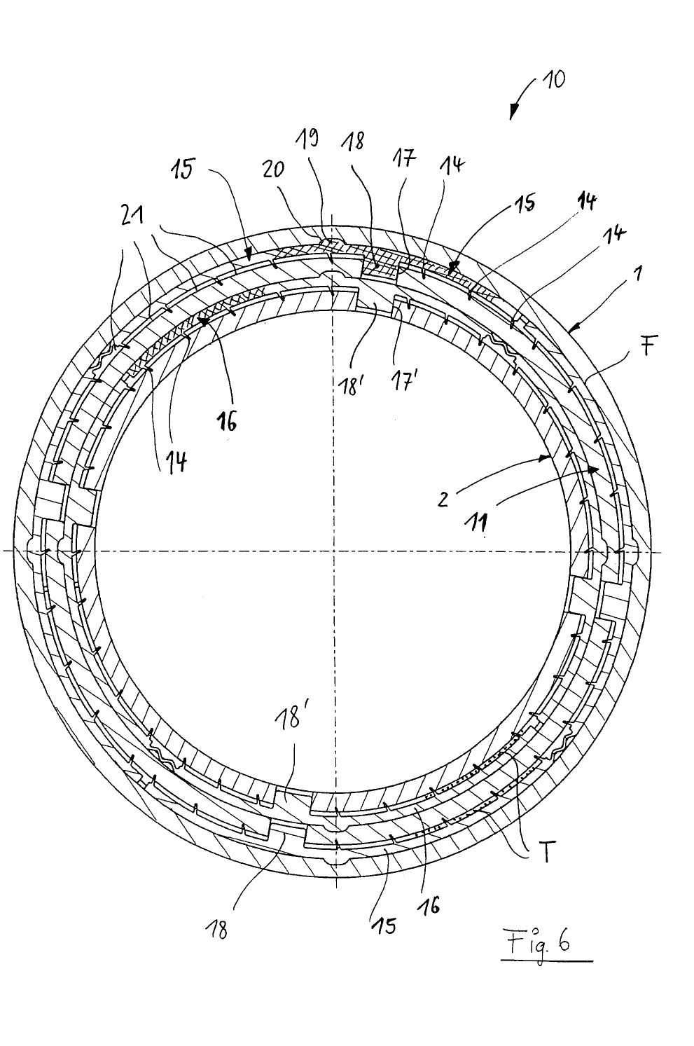

For forming the slide bearings G, G′, in the telescoping slide 10 support members 15, 16 and 15′, 16′, respectively, are provided (for improving the illustration cross-hatching is used partially) that form, on the one hand, the sliding surfaces F, F′ and, on the other hand, have shaped projections 14 for contacting the associated telescoping part 11, 2. In these support members, the shaped projections 14 provide an elastic contact structure like an elastic compensation layer (FIG. 1, FIG. 2) wherein this elasticity of the shaped projections 14 is illustrated in the drawings by means of visible “engagement tips” oriented toward the associated part, respectively (FIG. 6). It is understood that, when mounting the telescoping parts, these projection tips can undergo a substantially variable deformation and, in this way, the desired position compensation of the parts relative to one another is achieved.

In FIG. 6, a section view of the configuration of the lower slide support G is illustrated wherein in the right upper illustration area starting at the outer part 1 a central cylinder 11 associated as an inner part with the outer part 1 supports the support member 15. In the illustrated embodiment, these support members 15, 16, 15′, 16′ are formed as half shell parts (FIG. 7) on which at the inner sides the axially extending projections 14 are provided. In the mounted position according to FIG. 6, these shaped projections 14 rest against the central part 11 such that by means of the elastic support of the projections 14 the afore described centering action of the outer parts 1 relative to the center part 11 is achieved. For providing an axial securing action of the support member 15 on the center part 11 upon translatory loading in the direction of arrow A′, a securing groove 17 is provided that is in the form of a slotted hole and into which a corresponding securing projection 18 of the support members 15 can be inserted so that the connection of the parts is realized by positive engagement. On the outer circumference, the supporting member 15 has at least one guide projection 19 that engages axially slidingly a longitudinal groove 20 of the outer part 1. The securing projection 18 and the guide projection 19 form together a rotational securing means for the support member 15 so that it is secured in its mounted position against rotation in the radial direction.

In an expedient configuration, the support member 15 is provided in the circumferential direction with a plurality of projections 14 and at least two securing projections 18 (FIG. 6, FIG. 7). In the area between these two securing projections 18, the supporting member 15 has a connecting web E that acts like a film joint, facilitates mounting of the support member 15, and is able to compensate radial movements of the wall of the support member when being mounted.

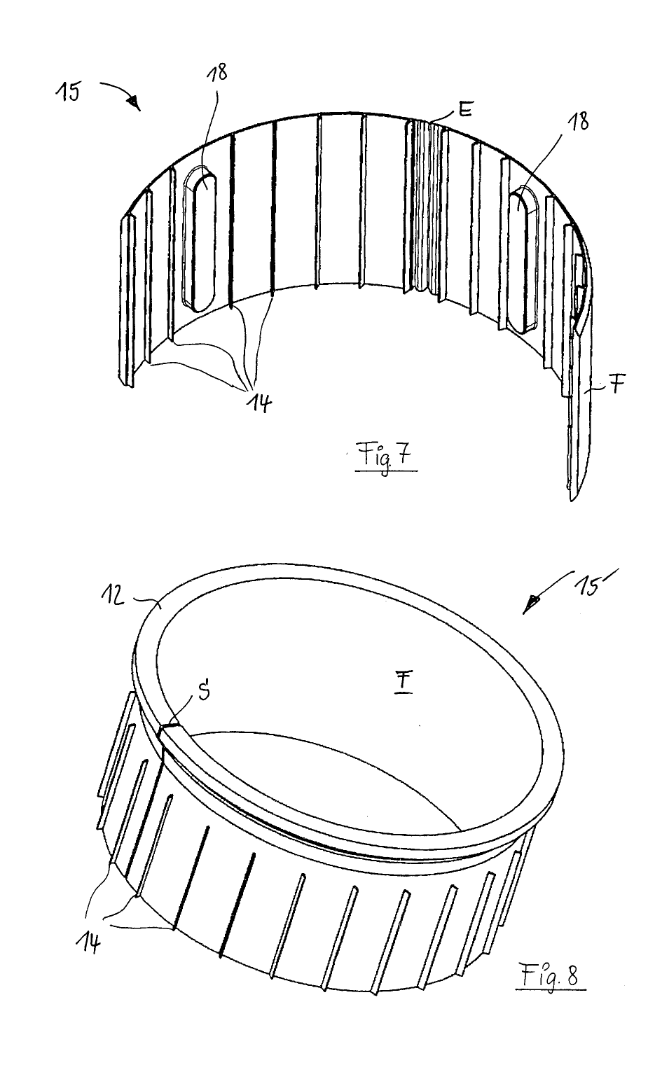

For completing the slide bearing G in the illustrated embodiment according to FIG. 6 two identical support members 15 are distributed about the circumference of the telescoping slide 10. It is also conceivable that the support member 15 is of a monolithic configuration as is illustrated, for example, in connection with the upper support member 15′ according to FIG. 8.

In the illustration according to FIG. 6 that shows a first mounting phase, the support member 15 is in a centering position that is effective like a compensation layer between the telescoping parts 1 and 11 or 11 and 2, wherein in a subsequent mounting step a hardening in the area of the shaped projections 14 is provided so that the optimal and long-term mounting position provided for the sliding support action of the axially moveable parts is permanently fixed. In an expedient configuration, a filler material (illustrated by a dotted zone T) is introduced at least partially into the area of the projections 14 and the receiving spaces (receptacles) 21 formed there between. With this filler material, the projections 14 are secured in position such that the support body 15 can receive radial pressure loads substantially free of any deformation. In this connection, a filler, for example, in the form of a curable or hardenable adhesive can be used for the fixation of the support bodies 15, 15′, 16, 16′.

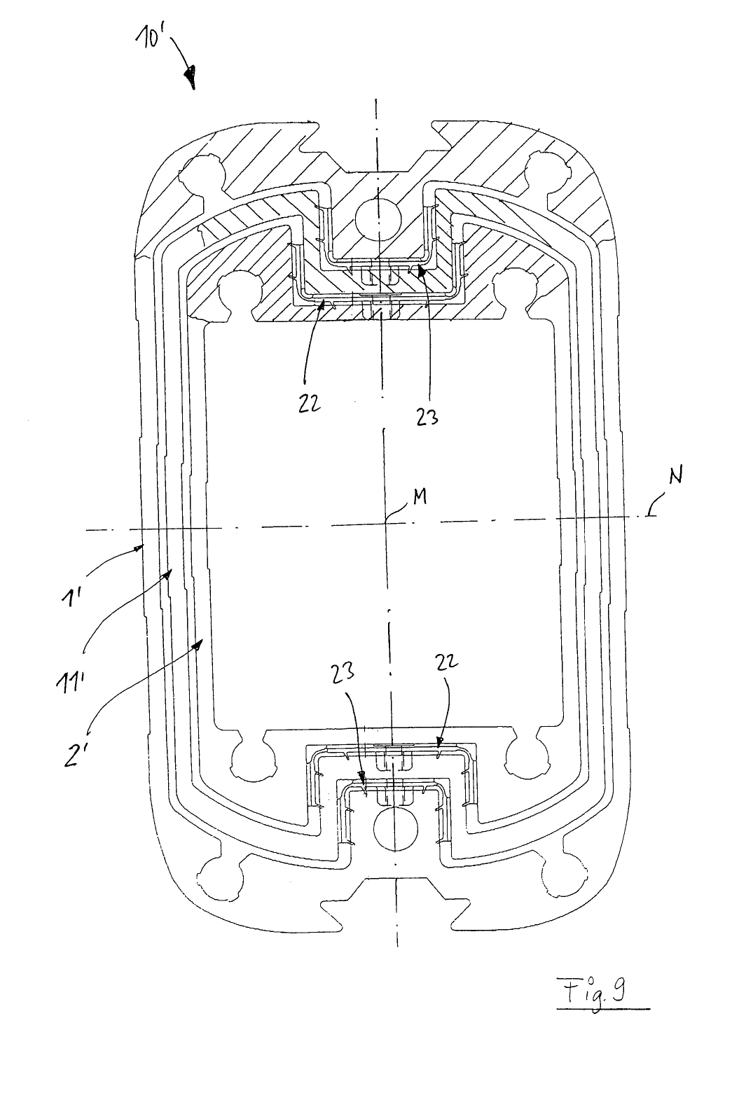

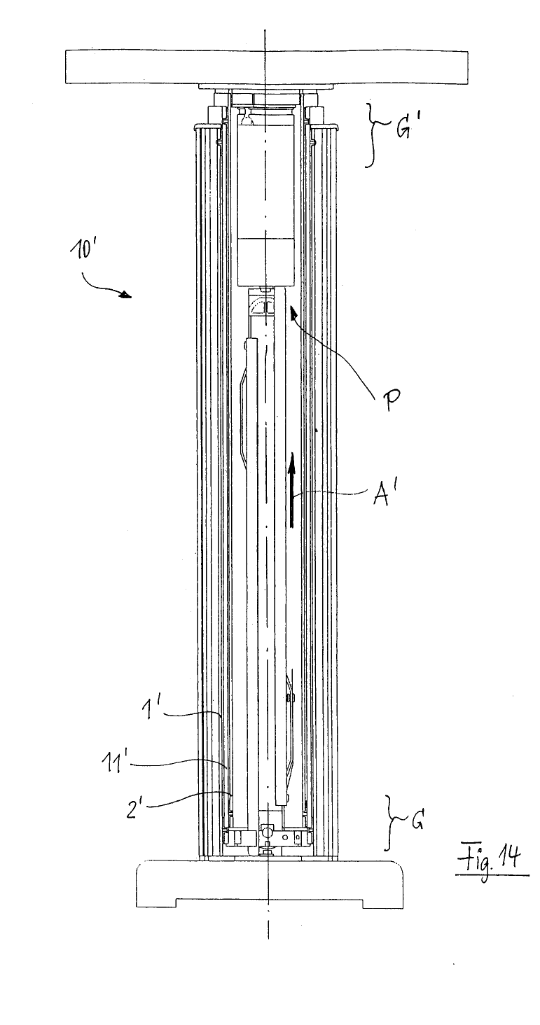

In FIG. 9, the telescoping slide 10′ is illustrated in a second embodiment wherein in this embodiment a substantially rectangular cross-sectional contour in the area of the components 1′, 11′, and 2′ is provided. With this configuration, support members 22, 23 are provided that are positioned opposite one another on the transverse slide and extend substantially mirror-symmetrically to the transverse plane N; in cross-section, they have a substantially U-shaped profile (FIG. 11, FIG. 13) with film joint parts E′. They are provided on the side opposite the sliding surface F, F′ with the afore described projections 14′.

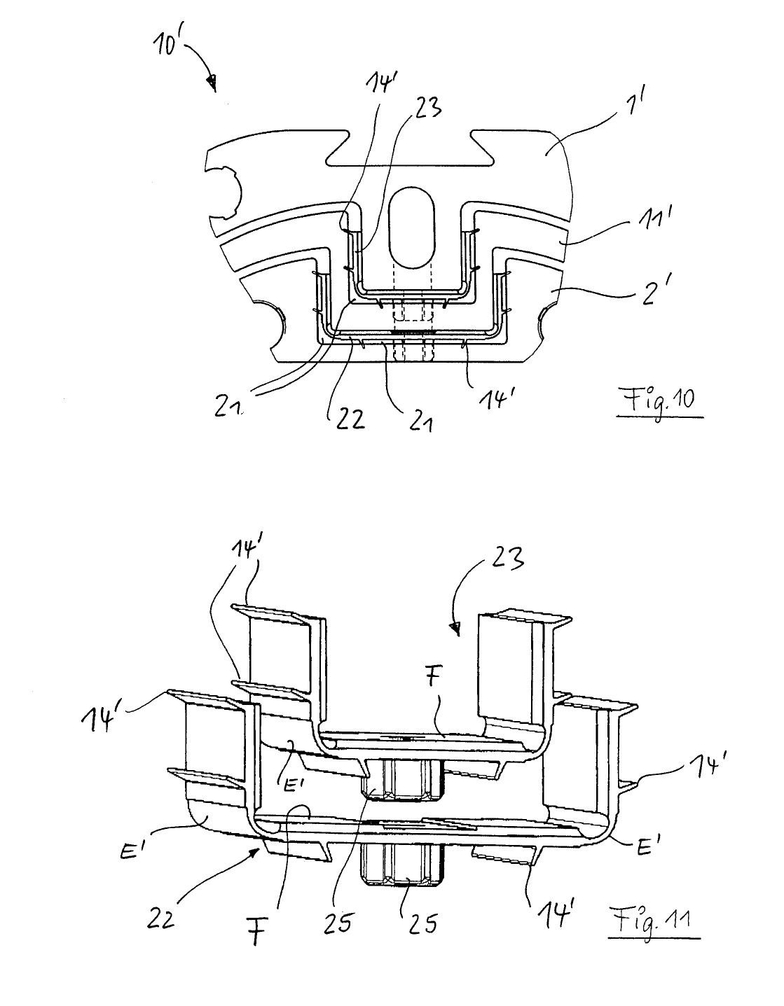

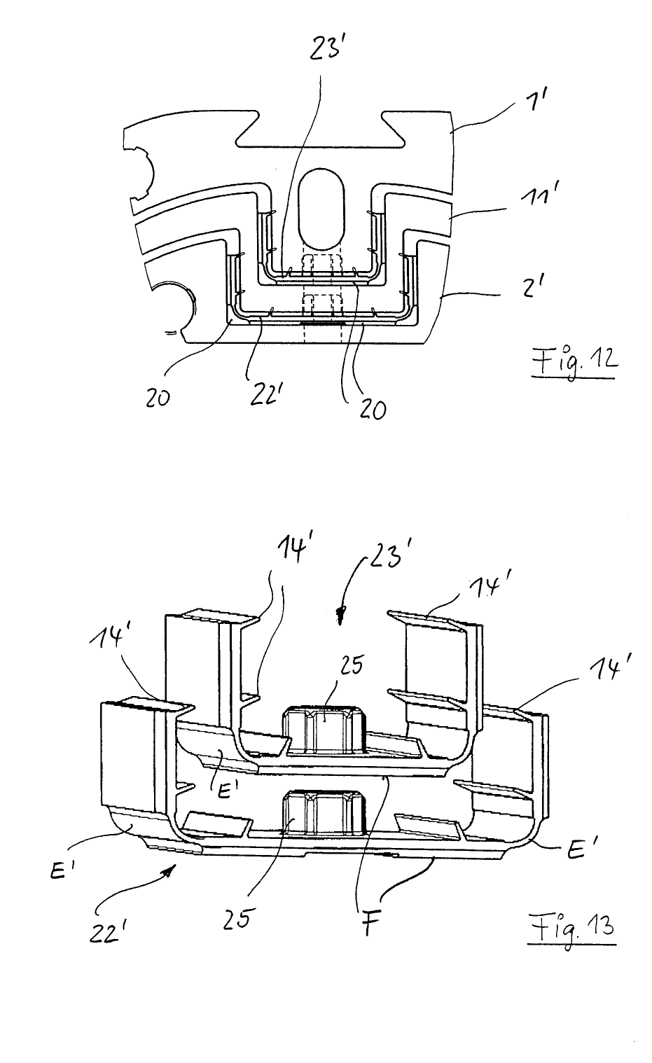

In FIGS. 10 and 11, the support bodies 22 provided in the area of the upper slide bearing G′ are illustrated; the illustrations according to FIGS. 12 and 13 show the configuration of the components 23 in the area of the lower slide bearing G. The shaped projections 14′ provided on the support members 22, 23 are effective in the same way as the described projections 14 of FIG. 6. For the fixation of the support bodies 22, 23 on the parts 1′ and 11′; 11′ and 2′ providing identical paired support areas, securing projections 25 in the form of multi-edge profiles are provided, respectively, that can be inserted into matching shaped recesses of the parts 1′, 2′, and 11′ in such away that for the desired axial movement of the telescoping parts relative to one another a safe sliding support is formed. In FIG. 14, an overview of a module corresponding to the telescoping slide 10′ is illustrated that is opened by a segment-shaped partial section to the inner part 2′ such that the inwardly positioned drive group P is visible also.

While specific embodiments of the invention have been shown and described in detail to illustrate the inventive principles, it will be understood that the invention may be embodied otherwise without departing from such principles.

1. A telescoping slide comprising:
an outer part and an inner part that is telescopingly movable within the outer part;
at least one slide bearing arranged between the outer and the inner parts for axially guiding the inner part within the outer part;
wherein the at least one slide bearing has at least one composite body comprised of at least one dimensionally stable support layer and at least one elastic compensation layer.

2. The telescoping slide according to claim 1, wherein during mounting of the at least one composite body the at least one compensation layer is converted from an elastic mounting state into an elastic deformed state of use.

3. The telescoping slide according to claim 1, wherein the at least one composite body in a mounting position is clamped between the inner and outer parts, wherein the elastically hardenable compensation layer provides a clamping position providing a centering action between the inner and the outer parts.

4. The telescoping slide according to claim 3, wherein the at least one compensation layer in the clamping position is at least partially hardenable.

5. The telescoping slide according to claim 4, wherein the at least one compensation layer is converted from the elastic mounting state with time delay into a completely hardened state of use.

6. The telescoping slide according to claim 1, wherein the at least one support layer and the at least one compensation layer of the composite body are formed of a plastic material, respectively.

7. The telescoping slide according to claim 1, wherein the at least one support layer is partially or completely comprised of a metallic material.

8. The telescoping slide according to claim 1, wherein the at least one support layer is partially or completely comprised of a non-metallic material.

9. The telescoping slide according to claim 1, wherein the at least one support layer and the at least one compensation layer are connected by at least one connection selected from the group of a material-bonding connection and a positive-locking connection.

10. The telescoping slide according to claim 1, wherein the at least one composite body is configured to have substantially any desired contour.

11. The telescoping slide according to claim 1, wherein the at least one support layer or the at least one compensation layer has a first side secured positively or non-positively on the outer part or on the inner part and has a second contact side opposite the first side, wherein the second contact side forms a sliding surface of the slide bearing.

12. The telescoping slide according to claim 11, wherein the at least one support layer or the at least one compensation layer is secured by a material-bonding connection to one of outer and the inner parts.

13. The telescoping slide according to claim 12, wherein the material-bonding connection is an adhesive connection of a soldering connection.

14. The telescoping slide according to claim 1, wherein the at least one composite body is inserted with pretension between the inner and outer parts and wherein the at least one composite body subsequently assumes a clamping position as a result of expansion of the at least one compensation layer.

15. The telescoping slide according to claim 11, wherein the contact side forming the sliding surface has optimal guiding and sliding properties relative to a surface of metal, non-metal, plastic material, and coatings.

16. The telescoping slide according to claim 1, wherein the inner and outer parts have several of the at least one several composite body arranged therebetween, wherein the composite bodies are spaced apart from one another in a telescoping direction of the telescoping slide, and wherein the composite bodies are alternatingly stationarily secured on the outer part or the inner part.

17. The telescoping slide according to claim 1, wherein the at least one compensation layer has a thickness selected such that dimensional tolerances of the at least one slide bearing are compensated.

18. The telescoping slide according to claim 1, wherein the inner and outer parts have a circular, oval, elliptical, triangular, quadrangular or polygonal cross-section and wherein a cross-sectional contour and a longitudinal contour of the at least one composite body are matched to the cross-section of the inner and outer parts.

19. A telescoping slide comprising:
an outer part and an inner part that is telescopingly movable within the outer part;
at least one slide bearing arranged between the outer and the inner parts for axially guiding the inner part within the outer part;
wherein the at least one slide bearing has at least one monolithic support member having a first side forming a sliding surface on a first one of the inner and outer parts and having a second side provided with shaped projections that, in a mounted position of the at least one slide bearing, provide an elastic contact structure on a second one of the inner and outer parts.

20. The telescoping slide according to claim 19, wherein the shaped projections, when mounting the support member, assume an elastically deformed position of use and act as a compensation layer effecting centering of the inner and outer parts relative to one another.

21. The telescoping slide according to claim 19, wherein the at least one support member comprises a dimensionally stable support layer and is configured to be reinforced in the area of the shaped projections.

22. The telescoping slide according to claim 19, wherein the at least one support member in the mounted position defines receptacles between the shaped projections and the second one of the inner and outer parts, wherein a filler material is introduced at least partially into the receptacles.

23. The telescoping slide according to claim 22, wherein the at least one support member is secured in the position of use by the filler material that is a curable adhesive.

24. The telescoping slide according to claim 19, wherein the at least one support member has a contour matched to a cross-section of the telescoping slide and is a half shell or a U-shaped profiled section, wherein the shaped projections extend axially and are monolithic parts of the half shell or the U-shaped profiled section.
